(19) United States
(12) Patent Application Publication
(10) Pub. No.: US 2026/0370257 A1
(43) Pub. Date: Nov. 19, 2026

(54) METHODS, DEVICES, AND MEDIUM OF COMMUNICATION

(71) Applicant: Minghui XU

(72) Inventor: Minghui XU

(21) Appl. No.: 19/148,076

(22) PCT Filed: Jan. 19, 2023
(86) PCT No.: PCT/CN2023/073205

§ 371 Date: Jul. 15, 2025

(51) Int. Cl. H04B 1/7143

(52) U.S. Cl. CPC H04B 1/7143

(57) ABSTRACT

Example embodiments of the present disclosure relate to methods, devices, and computer storage medium of communication. A network device receives, from a terminal device, at least one of capability information of the terminal device associated with frequency hopping of a reference signal for positioning the terminal device, or estimation information of the terminal device; determines a positioning requirement for positioning the terminal device; determines at least one of a set of parameters of a frequency hopping pattern of the reference signal or a set of thresholds for determining the set of parameters, based on at least one of the capability information, the positioning requirement, or the estimation information; and transmits, to the terminal device, at least one of the parameters or the thresholds. As such, a frequency hopping pattern is defined to enable the frequency hopping scheme to ensure a high enough accuracy of positioning for the terminal device.

### FIELD

Embodiments of the present disclosure generally relate to the field of communication techniques, and in particular, to methods, devices, and a computer readable medium of communication.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

For positioning of a terminal device, for example a RedCap UE, support of a reference signal (e.g. PRS or SRS) frequency hopping is recommended for normative work. However, the details of the frequency hopping pattern determination of the reference signal is undiscussed.

### SUMMARY

In general, example embodiments of the present disclosure provide methods, devices and a computer storage medium of communication.

In a first aspect, there is provided a method of communication. The method comprises: receiving, at a network device from a terminal device, at least one of capability information of the terminal device associated with frequency hopping of a reference signal for positioning the terminal device, or estimation information of the terminal device; determining a positioning requirement for positioning the terminal device; determining at least one of a set of parameters of a frequency hopping pattern of the reference signal or a set of thresholds for determining the set of parameters, based on at least one of the capability information, the positioning requirement, or the estimation information; and transmitting, to the terminal device, at least one of the set of parameters or the set of thresholds for determining the set of parameters.

In a second aspect, there is provided a method of communication. The method comprises: transmitting, at a terminal device to a network device, at least one of capability information of the terminal device associated with frequency hopping of a reference signal for positioning the terminal device, or estimation information of the terminal device; receiving, from the network device, a set of parameters of a frequency hopping pattern or a set of thresholds for determining the set of parameters, the set of parameters or the set of thresholds being determined based on at least one of the capability information, a positioning requirement for positioning the terminal device, or the estimation information; and transmitting or receiving the reference signal based on the frequency hopping pattern.

In a third aspect, there is provided a method of communication. The method comprises: determining, at a network device, energy per resource element (EPRE) of a reference signal for positioning a terminal device based on at least one of a comb size of the reference signal, a frequency hopping pattern of the reference signal, or a positioning requirement for positioning the terminal device; and transmitting an indication of the EPRE to the terminal device.

In a fourth aspect, there is provided a method of communication. The method comprises: receiving, at a terminal device from a network device, an indication of energy per resource element (EPRE) determined based on at least one of a comb size of a reference signal, a frequency hopping pattern of the reference signal, or a positioning requirement for positioning the terminal device; and transmitting or receiving the reference signal based on the EPRE.

In a fifth aspect, there is provided a network device. The network device comprises a processor; and a memory storing computer program codes; the memory and the computer program codes configured to, with the processor, cause the network device to perform the method according to the first aspect or the third aspect above.

In a sixth aspect, there is provided a terminal device. The terminal device comprises a processor; and a memory storing computer program codes; the memory and the computer program codes configured to, with the processor, cause the terminal device to perform the method according to the second aspect or the fourth aspect above.

In a seventh aspect, there is provided a computer readable medium having instructions stored thereon, the instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a schematic diagram illustrating a process of communication between a terminal device and a network device according to some embodiments of the present disclosure;

FIG. 3 illustrates sub-bands of the frequency hopping pattern according to some embodiments of the present disclosure;

FIG. 4 illustrates a schematic diagram illustrating a process of communication between a terminal device and a network device according to some other embodiments of the present disclosure;

FIG. 5 illustrates a schematic diagram of increasing EPRE for the PRS/SRS of the whole bandwidth according to some embodiments of the present disclosure;

FIG. 6 illustrates a schematic diagram of increasing EPRE for the PRS/SRS of the whole bandwidth according to some other embodiments of the present disclosure;

FIG. 7 illustrates a schematic diagram of increasing EPRE for the PRS/SRS of the overlapped bandwidth according to some other embodiments of the present disclosure;

FIG. 8 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, an unmanned aerial systems (UAS) platform, a Node B (NodeB or NB), an evolved NodeB (cNodeB or cNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like. In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

According to 3GPP Conference on RAN1 #111, the following in the TR conclusions are captured: from RAN1 perspective, for positioning of RedCap UEs, support of PRS frequency hopping and SRS frequency hopping is recommended for normative work. During the normative phase, the complexity of the corresponding capabilities for RedCap UEs should be addressed for the introduction of appropriate capabilities for RedCap UEs. In addition, the following are captured in section 6.5.3 of the TR: the following has been identified for potential specification impact of NR positioning for RedCap UEs: maximum tolerable phase error (phase error also may be referred to as phase offset), timing gap, and timing error between hops, and considerations for industrial internet of things (IIoT), commercial, Public Safety and V2X scenarios, and UE capabilities; details on the Tx or Rx hopping pattern(s), including frequency overlapping between hops, if supported.

At RAN1 #111 meeting, the following observations in the TR are updated: regarding the performance for positioning of Redcap UEs using frequency hopping in IIoT scenarios, considering phase offset between hops: in FR1, based on the results provided by the following sources, if the phase offset between hops in Frequency hopping is compensated, for indoor factory with sparse clutter (InF SH) the positioning requirement for IIoT use cases can be achieved using frequency hopping with partial overlap for the purpose of phase offset compensation. Some sources show that UL TDOA can meet the requirements. Some sources show that DL TDOA can meet the requirements. Some sources show that the requirement cannot be met, even if the phase is compensated. If the phase offset between hops in Frequency hopping is not compensated. Some sources show that DL TDOA can meet the requirements if the random phase offset is set to be equal or smaller than 0.2*2π. Some sources show that DL TDOA cannot meet the requirement with the random phase offset distributed from [−π, π].

For PRS receiving procedure, the UE can be configured with one or more DL PRS resource set configuration(s) as indicated by the higher layer parameters NR-DL-PRS-ResourceSet and NR-DL-PRS-Resource as defined by Clause 6.4.3 [17, TS 37.355]. Each DL PRS resource set consists of K>1 DL PRS resource(s) where each has an associated spatial transmission filter. The UE can be configured with one or more DL PRS positioning frequency layer configuration(s) as indicated by the higher layer parameter NR-DL-PRS-PositioningFrequencyLayer. A DL PRS positioning frequency layer is defined as a collection of DL PRS resource sets which have common parameters configured by NR-DL-PRSPositioningFrequencyLayer.

The UE expects that it will be configured with dl-PRS-ID each of which is defined such that it is associated with multiple DL PRS resource sets. The UE expects that one of these dl-PRS-ID along with a nr-DL-PRS-ResourceSetID and a nr-DL-PRS-ResourceID-r16 can be used to uniquely identify a DL PRS resource. The UE may be configured by the network with nr-PhysCellID, nr-CellGlobalID, and nr-ARFCN [17, TS 37.355] associated with a dl-PRS-ID.

The UE may be indicated by the network that DL PRS resource(s) can be used as the reference for the DL RSTD, DL PRS-RSRP, and UE Rx-Tx time difference measurements in a higher layer parameter nr-DL-PRS-ReferenceInfo. The reference indicated by the network to the UE can also be used by the UE to determine how to apply higher layer parameters nr-DL-PRS-ExpectedRSTD and nr-DL-PRS-ExpectedRSTD-Uncerainty. The UE expects the reference to be indicated whenever it is expected to receive the DL PRS. This reference provided by nr-DL-PRS-ReferenceInfo may include a dl-PRS-ID, a DL PRS resource set ID, and optionally a single DL PRS resource ID or a list of DL PRS resource IDs [17, TS 37.355].

The UE may use different DL PRS resources or a different DL PRS resource set to determine the reference for the RSTD measurement as long as the condition that the DL PRS resources used belong to a single DL PRS resource set is met. If the UE chooses to use a different reference than indicated by the network, then it is expected to report the dl-PRS-ID, the DL PRS resource ID(s) or the DL PRS resource set ID used to determine the reference.

Common NR positioning information elements are as follows:

NR-DL-PRS-AssistanceData-r16 ::= SEQUENCE {
nr-DL-PRS-ReferenceInfo-r16 DL-PRS-ID-Info-r16,
nr-DL-PRS-AssistanceDataList-r16 SEQUENCE (SIZE
(1 . . . nrMaxFreqLayers-r16)) OF NR-DL-PRS-
AssistanceDataPerFreq-r16,
nr-SSB-Config-r16 SEQUENCE (SIZE
(1 . . . nrMaxTRPs-r16)) OF
NR-SSB-Config-r16 OPTIONAL, -- Need ON
. . .
}
NR-DL-PRS-AssistanceDataPerFreq-r16 ::= SEQUENCE {
nr-DL-PRS-PositioningFrequencyLayer-r16
NR-DL-PRS-PositioningFrequencyLayer-r16,
nr-DL-PRS-AssistanceDataPerFreq-r16 SEQUENCE (SIZE
(1 . . . nrMaxTRPsPerFreq-r16)) OF NR-DL-PRS-
AssistanceDataPerTRP-r16,
. . .
}
NR-DL-PRS-AssistanceDataPerTRP-r16 ::= SEQUENCE {
dl-PRS-ID-r16 INTEGER (0 . . . 255),
nr-PhysCellID-r16 NR-PhysCellID-r16 OPTIONAL,
-- Need ON
nr-CellGlobalID-r16 NCGI-r15 OPTIONAL, -- Need ON
nr-ARFCN-r16 ARFCN-ValueNR-r15 OPTIONAL,
-- Need ON
nr-DL-PRS-SFN0-Offset-r16 NR-DL-PRS-
SFN0-Offset-r16,
nr-DL-PRS-ExpectedRSTD-r16 INTEGER
(−3841 . . . 3841),
nr-DL-PRS-ExpectedRSTD-Uncertainty-r16 INTEGER
(0 . . . 246),
nr-DL-PRS-Info-r16 NR-DL-PRS-Info-r16,
. . .
}
NR-DL-PRS-PositioningFrequencyLayer-r16 ::=
SEQUENCE {
dl-PRS-SubcarrierSpacing-r16 ENUMERATED
{kHz15, kHz30, kHz60,
kHz120, . . .},
dl-PRS-ResourceBandwidth-r16 INTEGER (1 . . . 63),
dl-PRS-StartPRB-r16 INTEGER (0 . . . 2176),
dl-PRS-PointA-r16 ARFCN-ValueNR-r15,
dl-PRS-CombSizeN-r16 ENUMERATED
{n2, n4, n6, n12, . . .},
dl-PRS-CyclicPrefix-r16 ENUMERATED
{normal, extended, . . .},
. . .
}

Radio resource control information elements related to positioning SRS are as follows:

SRS-Config ::= SEQUENCE {
srs-ResourceSetToReleaseList SEQUENCE
(SIZE(1 . . . maxNrofSRS-ResourceSets)) OF SRS-ResourceSetId
OPTIONAL,
-- Need N
srs-ResourceSetToAddModList SEQUENCE
(SIZE(1 . . . maxNrofSRS-ResourceSets)) OF SRS-ResourceSet
OPTIONAL,
-- Need N
srs-ResourceToReleaseList SEQUENCE
(SIZE(1 . . . maxNrofSRS-Resources)) OF SRS-ResourceId
OPTIONAL, -- Need N
srs-ResourceToAddModList SEQUENCE
(SIZE(1 . . . maxNrofSRS-Resources)) OF SRS-Resource
OPTIONAL, -- Necd N
. . .
[[
. . .
srs-PosResourceSetToReleaseList-r16 SEQUENCE
(SIZE(1 . . . maxNrofSRS-PosResourceSets-r16))
OF SRS-PosResourceSetId-r16
OPTIONAL, -- Need N
srs-PosResourceSetToAddModList-r16 SEQUENCE
(SIZE(1 . . . maxNrofSRS-PosResourceSets-r16))
OF SRS-PosResourceSet-r16
OPTIONAL, -- Need N
srs-PosResourceToReleaseList-r16 SEQUENCE
(SIZE(1 . . . maxNrofSRS-PosResources-r16))
OF SRS-PosResourceId-r16
OPTIONAL, -- Need N
srs-PosResourceToAddModList-r16 SEQUENCE
(SIZE(1 . . . maxNrofSRS-PosResources-r16))
OF SRS-PosResource-r16
OPTIONAL -- Need N
]]
. . .
}
SRS-PosResource-r16 ::= SEQUENCE {
srs-PosResourceId-r16 SRS-PosResourceld-r16,
transmissionComb-r16 CHOICE {
n2-r16 SEQUENCE {
combOffset-n2-r16 INTEGER (0 . . . 1),
cyclicShift-n2-r16 INTEGER (0 . . . 7)
},
n4-r16 SEQUENCE {
combOffset-n4-r16 INTEGER (0 . . . 3),
cyclicShift-n4-r16 NTEGER (0 . . . 11)
},
n8-r16 SEQUENCE {
combOffset-n8-r16 INTEGER (0 . . . 7),
cyclicShift-n8-r16 INTEGER (0 . . . 5)
},
. . .}

Radio resource control information related to measurement gap configuration are as follows:

MeasGapConfig ::= SEQUENCE {
gapFR2 SetupRelease {GapConfig} OPTIONAL, -- Need M
. . .,
[[
gapFR1 SetupRelease {GapConfig} OPTIONAL, -- Need M
gapUE SetupRelease {GapConfig} OPTIONAL -- Need M
]],
[[
gap ToAddModList-r17 SEQUENCE (SIZE
(1 . . . maxNrofGapId-r17)) OF GapConfig-r17
OPTIONAL, -- Need N
gap ToReleaseList-r17 SEQUENCE (SIZE
(1 . . . maxNrofGapId-r17)) OF MeasGapId-r1
OPTIONAL, -- Need N
]]
}
GapConfig-r17 ::= SEQUENCE {
measGapId-r17 MeasGapId-r17,
gap Type-r17 ENUMERATED {perUE, perFR1, perFR2},
gapOffset-r17 INTEGER (0 . . . 159),
ENUMERATED {ms1, ms1dot5, ms2, ms3, ms3dot5,
ms4, ms5, ms5dot5, ms6, ms10, ms20},
mgrp-r17 ENUMERATED {ms20, ms40, ms80, ms160},
mgta-r17 ENUMERATED {ms0, ms0dot25, ms0dot5,
ms0dot75},
refServCellIndicator-r17 ENUMERATED
{pCell, pSCell, mcg-FR2}
OPTIONAL, -- Cond NEDCorNRDC
refFR2-ServCellAsyncCA-r17 ServCellIndex
OPTIONAL, --
Cond AsyncCA
preConfigInd-r17 ENUMERATED {true}
OPTIONAL, -- Need R
ncsgInd-r17 ENUMERATED {true}
OPTIONAL, -- Need R
gapAssociationPRS-r17 ENUMERATED {true}
OPTIONAL, -- Need R
gapSharing-r17 MeasGapSharingScheme
OPTIONAL, -- Need R
gapPriority-r17 GapPriority-r17
OPTIONAL, -- Need R

According to current 3GPP meeting discussion/agreement, the defining of hopping pattern and related configuration need to be solved.

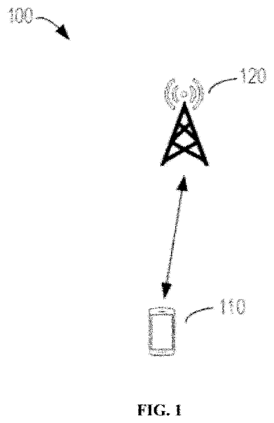

FIG. 1 illustrates an example communication system 100 in which some embodiments of the present disclosure can be implemented. The communication system 100, which is a part of a communication network, includes a network device 120 and a terminal device 110.

The network device 120 can provide services to the terminal device 110, and the network device 120 and the terminal device 110 may communicate data and control information with each other. In some embodiments, the network device 120 and the terminal device 110 may communicate with direct links/channels.

In the system 100, a link from the network device 120 to the terminal device 110 is referred to as a downlink (DL), while a link from the terminal device 110 to the network device 120 is referred to as an uplink (UL). In downlink, the network device 120 is a transmitting (TX) device (or a transmitter) and the terminal device 110 is a receiving (RX) device (or a receiver). In uplink, the terminal device 110 is a transmitting TX device (or a transmitter) and the network device 120 is a RX device (or a receiver). It is to be understood that the network device 120 may provide one or more serving cells. In some embodiments, the network device 120 can provide multiple cells. The numbers of devices and their connection relationships and types shown in FIG. 1 are only for the purpose of illustration without suggesting any limitation. The communication system 100 may include any suitable numbers of devices adapted for implementing embodiments of the present disclosure.

The communications in the communication system 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the network device 120 can transmit a set of positioning reference signals (PRSs) to the terminal device 110, and the terminal device 110 can measure the PRSs. In some embodiments, the terminal device 110 can transmit a sounding reference signal to the network device 120. In some embodiments, the terminal device 110, such as reduced capability UE could support NR positioning functionality.

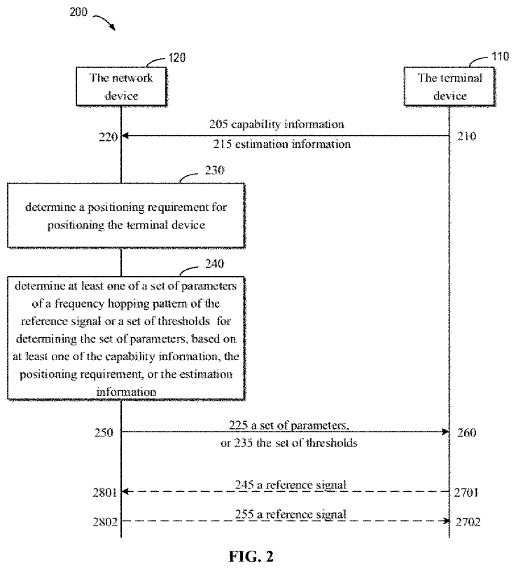

FIG. 2 illustrates a schematic diagram illustrating a process of communication between a terminal device 110 and a network device 120. As shown in FIG. 2, in process 200, the terminal device 110 may transmit (210), to the network device 120, at least one of capability information 205 of the terminal device 110 associated with frequency hopping of a reference signal for positioning the terminal device 110, or estimation information 215 of the terminal device 110. On the network side, the network device 120 may receive (220), from the terminal device 110, at least one of the capability information 205 of the terminal device 110 associated with frequency hopping of the reference signal for positioning the terminal device 110, or the estimation information 215 of the terminal device 110. The network device 120 may determine (230) a positioning requirement for positioning the terminal device 110. The network device 120 may determine (240) at least one of a set of parameters 225 of a frequency hopping pattern of the reference signal or a set of thresholds 235 for determining the set of parameters 225, based on at least one of the capability information 205, the positioning requirement, or the estimation information 215. The network device 120 may transmit (250), to the terminal device 110, at least one of the set of parameters 225 or the set of thresholds 235 for determining the set of parameters 225. On the terminal device 110 side, the terminal device 110 may receive (260), from the network device 120, the set of parameters 225 of a frequency hopping pattern or the set of thresholds 235 for determining the set of parameters 225. As mentioned above, the set of parameters 225 or the set of thresholds 235 may be determined based on at least one of the capability information 205, the positioning requirement for positioning the terminal device 110, or the estimation information 215. The terminal device 110 may transmit (2701) or receive (2702) the reference signal (245 or 255) based on the frequency hopping pattern. On the network device 120 side, the network device 120 may receive (2801) or transmit (2802) the reference signal (245 or 255). In some embodiments, the reference signal 245 may be sounding reference signal (SRS) 245, and the terminal device 110 may transmit (2701) the SRS 245 to the network device 120. In some embodiments, the reference signal 255 may be positioning reference signal (PRS) 255, and the network device 120 may transmit (2802) the PRS 255 to the terminal device 110.

In some embodiments, the capability information of the terminal device 110 may comprise one of more of a distribution of a phase offset during the frequency hopping between two consecutive sub-bands of the reference signal, a distribution of a time error during the frequency hopping between the two consecutive sub-bands of the reference signal, a minimum time gap between the two consecutive sub-bands for the frequency hopping of the reference signal, and a maximum number of sub-bands of the reference signal.

In some embodiments, the capability information of the terminal device 110 may comprise granularity for determining the sub-bands in frequency domain. The granularity for determining the sub-bands in frequency domain is a condition to be satisfied when defining the sub-bands. In some embodiments, granularity for determining the sub-bands in frequency domain may be granularity for setting the start point of each sub-band in frequency domain, that is, a condition for the start point to satisfy. For example, the granularity is 5 MHz (or an another value), then the start point of the sub-band in frequency domain should be integer multiple of the 5 MHz (or the another value).

In some embodiments, the set of parameters may comprise one or more of the number of the sub-bands, a size of an overlapped bandwidth between the two consecutive sub-bands, a time gap between the two consecutive sub-bands, a size of a sub-band, a size of a total bandwidth of a plurality of sub-bands of the frequency hopping pattern, a location of a sub-band, the number of symbols per sub-band, and a total time duration of the plurality of sub-bands of the frequency hopping pattern.

In some embodiments, in order to determine the set of parameters, the network device 120 may perform: based on at least one of the phase offset or the time error, and a positioning requirement on at least one of the phase offset or the time error, determining existence of the overlapped bandwidth between the sub-bands; and determining the size of the overlapped bandwidth based on association of the size of the overlapped bandwidth and at least one of: a signal-to-noise ratio (SNR), a signal to interference plus noise ratio (SINR), reference signal received power (RSRP) or a modulation and scheme (MCS). Either the positioning requirement on the phase offset or the positioning requirement on the time error is an example of the positioning requirement for positioning the terminal device 110 determined by the network device 120.

In some embodiments, the network device 120 may determine the existence of the overlapped bandwidth between the sub-bands by determining that the phase offset is greater than a first predefined value. Alternatively, or additionally, the network device 120 may determine the existence of the overlapped bandwidth between the sub-bands by determining that the phase offset is greater than a second predefined value, and the time error is greater than a third predefined value. Alternatively, the network device 120 may determine the existence of the overlapped bandwidth between the sub-bands by determining a value of a cost function associated with the phase offset and the time error larger than a fourth predefined value. The first predefined value, the second predefined value, the third predefined value, or the fourth predefined value may be associated with the positioning requirement.

In some embodiments, multiple associations between the size of the overlapped bandwidth and at least one of the SNR, the SINR, the RSRP or the MCS are predefined or pre-configured for different time errors. Based on the time error, the network device 120 may determine one of them to be the association of the size of the overlapped bandwidth and at least one of the SNR, the SINR, the RSRP or the MCS, for determining the overlapped bandwidth implicitly.

In some embodiments, in order to determine the set of parameters, specifically, the network device 120 may determine the time gap between the sub-bands. Based on one or more of the minimum time gap, a measurement gap for a plurality of reference signals including the reference signal, speed information reported by the terminal device 110, and the number of the sub-bands, the network device 120 may determine the time gap between the sub-bands.

In some embodiments, in order to determine the set of parameters, specifically, the network device 120 may determine the size of a total bandwidth of a plurality of sub-bands of the frequency hopping pattern as a fixed value, and may determine the size of the sub-band as a maximum bandwidth supported by the terminal device 110.

In some embodiments, in order to determine the set of parameters, specifically, based on the fixed value of total bandwidth, the size of the sub-band, and the size of the overlapped bandwidth, the network device 120 may determine the number of the sub-bands.

In some embodiments, in order to determine the set of parameters, specifically, based on the size of the total bandwidth of the plurality of sub-bands of the frequency hopping pattern, a defined maximum number of the plurality of sub-bands, and a defined maximum time duration for the plurality of sub-bands, the network device 120 may determine the number of sub-bands. In some embodiments, the size of the total bandwidth may be fixed or defined by the network device 120. In some embodiments, the size of the total bandwidth may be associated with the positioning requirement.

In some embodiments, the network device 120 may determine the defined maximum number of the plurality of sub-bands, based on at least one of subcarrier spacing (SCS) of the reference signal or the capability information of the terminal device 110. In some embodiments, higher the SCS, larger the maximum number of the plurality of sub-bands. In some other embodiments, higher the SCS, smaller the maximum number of the plurality of sub-bands. By this way, the defined maximum number of the plurality of sub-bands is related to the SCS.

In some embodiments, the network device 120 may determine the defined maximum time duration for the plurality of sub-bands, based on one or more of a measurement gap for a plurality of reference signals including the reference signal, speed information of the terminal device 110 and a configuration of additional demodulation reference signal (DMRS).

In some embodiments, a format of the speed information may be an absolute speed or both the absolute speed and a moving direction of the terminal device 110. In some embodiments, a format of the speed information may be a speed level or both the speed level and a moving direction grid of the terminal device 110. In some embodiments, a format of the speed information may be a quantized speed or both the quantized speed and a direction of the terminal device 110.

In some embodiments, the estimation information may comprise a signal-to-noise ratio (SNR) or a signal to interference plus noise ratio (SINR) received from the terminal device 110 via a radio resource control (RRC) signaling. On the terminal device 110 side, the terminal device 110 may report a measured SNR or a measured SINR to the network device 120 for determining the set of parameters. Alternatively, or additionally, in some embodiments, the estimation information may comprise the speed information of the terminal device 110. On the terminal device 110 side, the terminal device 110 may transmit, to the network device 120, the speed information of the terminal device 110 measured based on received reference signal or obtained from a sensor or sensors of the terminal device 110. In some embodiments, the measured SNR/SINR above is a SNR/SINR dedicated for positioning the terminal device 110.

In some embodiments, the positioning requirement may comprise one or more of a phase offset requirement during the frequency hopping between two consecutive sub-bands of the reference signal, a time error requirement during the frequency hopping between the two consecutive sub-bands, a time gap requirement between the sub-bands, and a required positioning accuracy in vertical and horizontal.

In some embodiments, the positioning requirement above may be received from the terminal device 110, in other words, the terminal device 110 may transmit, to the network device 120, the positioning requirement for positioning the terminal device 110.

In some embodiments, on the terminal device 110 side, the terminal device 110 may determine the frequency hopping pattern for transmitting or receiving the reference signal, based on the set of thresholds and the capability information.

Take the terminal device 110 as a RedCap UE (reduced capability UE) for example, the embodiments of the present disclosure will be further introduced below. According to some embodiments, by determining the hopping pattern according to capability of the terminal device 110, alternatively, or additionally, the estimation information, alternatively, or additionally, scenarios, the network device 120 of the present disclosure may solve the problem that the details of the frequency hopping pattern determination of PRS/SRS is undiscussed. The capability may correspond to the capability information above. The scenarios may correspond to the positioning requirement above. Different scenarios require different accuracy for positioning and different frequency hopping configuration for a same RedCap UE.

With respect to UE capability, in some embodiments, the UE (e.g. the RedCap UE) may report the UE type. In some embodiments, the UE may report the statistical characteristics of phase error for DL reception/UL transmission. Larger phase error, larger size or an overlapped bandwidth. Separate configurations may be for UL SRS and DL PRS. In some embodiments, the UE may report the statistical characteristics of time error. In some embodiments, the UE may report a minimum time gap between two gaps, and the minimum time gap may be associated with a speed of the UE. In some embodiments, statistical characteristics includes at least one of the distribution type, such as uniform distribution, Gaussian distribution, normal distribution and so on, the detailed value of the distribution.

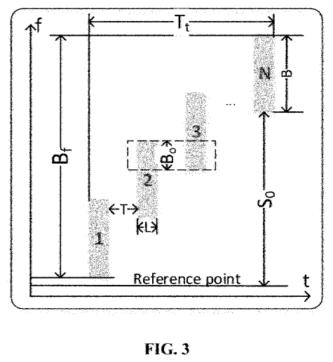

In some embodiments, the hopping pattern definition, may be as follows:
Same band width/time gap are applied to all the sub-bands and overlapped band, as shown in FIG. 3, the number of sub-bands is N, the size of overlapped bandwidth between the two consecutive sub-bands is Bₒ, the time gap between the two consecutive sub-bands is T, the size of each sub-bands is B, the total effective bandwidth (i.e. the size of a total bandwidth of a plurality of sub-bands of the frequency hopping pattern) is B_{f}, the location of each sub-bands for example corresponds to start point S₀, and the number of symbols per hopping sub-bands is L. By the way above, the set of parameters of the frequency hopping pattern may be defined. In addition, the set of parameters may further comprise the total time duration of the plurality of sub-bands of the frequency hopping pattern.

In some embodiments, according to the hopping pattern definition, different band width/time gap may be applied to different sub-bands/overlapped band. Start point of each sub-bands may be determined based on a start point in frequency domain and a start point in time domain. In some embodiments, an offset can be used to indicating the start point in both frequency domain and time domain, and for frequency domain, it may be the gap between the start points of two adjacent sub-bands, and for time domain, it may be the gap between the end point of the i-th sub-band and the start point of the (i+1)-th sub-band. The length of each sub-bands may comprise the length in frequency domain and the length in time domain. In some embodiments, for the same parameter of different sub-bands, if they have the same value, the value of the parameter may be defined by a common value. As an example, if the size of each sub-band in time domain or frequency domain is the same, then a common value can be indicated instead of separate value for each sub-band. Similarly, for other parameters, such as the start points of sub-bands in time domain or frequency domain are regularly, the size of the overlapped bandwidth between the two consecutive sub-bands are the same for different sub-bands, etc., a common value or a shared value can also be defined.

In some embodiments, the network device 120 may configure the hopping pattern according to the capability of the RedCap UE. A capability report of the RedCap UE may comprise one or more of:
Phase error during hopping sub-bands for transmitting signal/SRS;
Phase error during hopping sub-bands for receiving signal/PRS;
Time error during hopping sub-bands for transmitting signal/SRS;
Time error during hopping sub-bands for receiving signal/PRS;
Minimum time gap between hopping sub-bands for transmitting signal/SRS; and
Minimum time gap between hopping sub-bands for receiving signal/PRS;
Granularity for determining the sub-bands in frequency domain for transmitting signal/SRS;
Granularity for determining the sub-bands in frequency domain for receiving signal/PRS.

As mentioned above, the granularity for determining the sub-bands in frequency domain for transmitting/receiving the signal/PRS may be a condition to be satisfied when defining the sub-bands for transmitting/receiving the signal/PRS. In some embodiments, for example, the granularity above may be granularity for setting the start point of each sub-band in frequency domain.

It is to be noted that the phase error and the time error may be statistical characteristics. In some embodiments, the distribution of the statistical characteristics may comprise the type of the distribution and the value corresponding to the type. If the type of the distribution is predetermined or pre-defined, the UE may report the value merely. In some embodiments, there may be a plurality of sets of the values corresponding to settings of software or hardware of the UE respectively.

For the hopping pattern configuration, the network device 120 may configure the bandwidth size of overlapped bandwidth between two adjacent sub-bands. As mentioned above, based on at least one of the phase offset or the time error, and the positioning requirement on at least one of the phase offset or the time error, the network device 120 may determine the existence of the overlapped bandwidth between the sub-bands.

Specifically, presence of the overlapped bandwidth may associate with the phase error and/or time error. It's present when phase error (difference) larger than a predefined value PHE₁. It's present when phase offset (difference) larger than a predefined value PHE₂ and time error (difference) larger than a predefined value TE₁. It's present when a value of a cost function larger than a predefined value, and the cost function is defined by a function of phase offset and time error.

In some embodiments, the overlap bandwidth size may be associated with the SNR/SINR/RSRP. Lower SNR/SINR/RSRP, larger overlap bandwidth, to ensure the accuracy of the estimated phase offset. In some embodiments, different association tables for different time errors may be pre-defined or pre-configured. Larger time error, larger overlapped bandwidth for a same SNR. As shown in Table 1 and Table 2, if the time error <TE₀, the table 1 is applied for size of determining overlapped bandwidth, and if the time error ≥TE₀, the table 2 is applied for size of determining overlapped bandwidth.

TABLE 1

| SNR/SINR/RSRP | Overlapped bandwidth |
|---|---|
| SNR < TH₁ | 8RB |
| TH₁ <= SNR < TH₂ | 4RB |
| TH₂ <= SNR | 2RB |

TABLE 2

| SNR/SINR/RSRP | Overlapped bandwidth |
|---|---|
| SNR < TH_{A} | 8RB |
| TH_{A} <= SNR < TH_{B} | 4RB |
| TH_{B} <= SNR | 2RB |

It should be noted that TH₁≤TH₂, TH_{A}≤TH_{B}, TH₁≤TH_{A}, TH₂≤TH_{B} and the overlapped bandwidths values and the number of rows in the tables are just examples.

In some other embodiments of the network device 120 configuring the bandwidth size of overlapped bandwidth between two adjacent sub-bands. The overlap bandwidth size may be associated with the SNR/SINR/RSRP. Lower SNR/SINR/RSRP, larger overlap bandwidth, to ensure the accuracy of the estimated phase offset. In these embodiments, different association tables as Table 3 or Table 4 for different time errors may be defined. Larger time error, larger overlapped bandwidth for a same SNR, and if Time error <TE₀, the Table 3 is applied for size of determining overlapped bandwidth, and if time error ≥TE₀, the Table 4 is applied for size of determining overlapped bandwidth.

TABLE 3

| SNR/SINR/RSRP | Overlapped bandwidth |
|---|---|
| SNR < TH₁ | 4RB |
| TH₁ <= SNR < TH₂ | 2RB |
| TH₂ <= SNR | 1RB |

TABLE 4

| SNR/SINR/RSRP | Overlapped bandwidth |
|---|---|
| SNR < TH₁ | 8RB |
| TH₁ <= SNR < TH₂ | 4RB |
| TH₂ <= SNR | 2RB |

It should be noted that TH₁≤TH₂, and the overlapped bandwidths values and the number of rows in the tables are just examples.

In some embodiments, the SINR can be replaced by latest configured/scheduled MCS, or a static MCS in a time window with a pre-defined length, an exemplary relationship between the MCS index and the overlapped bandwidth may be as shown in Table 5.

TABLE 5

| MCS Index | Overlapped bandwidth |
|---|---|
| MCS < MCS₁ | 8RB |
| MCS₁ <= MCS < MCS₂ | 4RB |
| MCS₂ <= MCS | 2RB |

It should be noted that MCS₁≤MCS₂, and the overlapped bandwidths values and the number or rows in the tables are just examples.

As mentioned above, the overlap bandwidth size is associated with the SNR/SINR/RSRP. Lower SNR/SINR/RSRP, larger overlap bandwidth, so as to ensure the accuracy of the estimated phase offset. In some embodiments, there are some other considerations: the overlapped bandwidths values can be expressed by percentage values. The absolute maximum overlapped bandwidths are different for RedCap UEs with different maximum bandwidths. The SINR/SNR/MCS value can be a filtered static value in a long term time duration/window, in some embodiments, the SNR/SINR/MCS for overlap bandwidth size determination is a static value. In some other embodiments, the UE may report a special or dedicated measured SINR/SNR to base station (an example of the network device 120) via RRC for determining frequency hopping pattern for positioning reference signal, and the special value may be measured within a predefined or pre-configured time duration. In some other embodiments, the UE may determine the static MCS according to the scheduled MCS within a pre-defined or pre-configured time duration. In some other embodiments, gNB (an example of the network device 120) may determine the static SINR/SNR by implementation.

In some embodiments, RF returning is involved. The RF returning is an operation to reduce the phase offset during hopping sub-bands. RF returning operation may be associated with the SINR. The length of time duration reserved for RF returning is associated with (static) SNR/SINR/MCS. In some embodiments, for high SNR, there is no RF retuning. For low SNR, there is RF returning. In some embodiments, for high SNR, there is no RF returning. For medium SNR, RF returning with a short time duration. For low SNR, RF returning with a long time duration. A (static) SNR can be determined as one of high SNR, medium SNR and low SNR according to pre-defined or pre-configured thresholds. RF returning operation may influence the frequency hopping pattern: long time duration for RF returning corresponds to a small overlap size or no overlap size. Short time duration for RF returning corresponds to a large overlap size.

For the hopping pattern configuration, the network device 120 may configure the time gap between the two adjacent sub-bands. The time gap may be no shorter than the minimum gap reported by the RedCap UE, and make sure all the hopping sub-bands are within a same measurement gap. The time gap may be associated with the speed of the RedCap UE. Higher the speed, shorter the time gap. In some embodiments, a relationship between time gap and the UE speed may be pre-defined. The time gap may be also associated with the number of hopping sub-bands. Larger the number, shorter the time gap.

In some embodiments, the size of total bandwidth may be a fixed value, for example may be 100 MHz The hopping sub-bands may increase with the overlapped bandwidth. For example, a subcarrier spacing (SCS) is 120 kHz, and the sub-band size is 20 MHz, the overlapped size is 8 RB (11.52 MHz) and there are 9 hopping sub-bands. The overlapped size is 4 RB (5.76 MHz) and there are 6 hopping sub-bands.

In some embodiments, the size of total bandwidth may be configurable. Specifically, it may be defined by the minimum gap and the overlapped size, and may be no larger than 100 MHz.

In some embodiments, the network device 120 may define the maximum number of the sub-band for frequency hopping, and the maximum number of the sub-band for frequency hopping may be associated with the SCS: higher SCS, larger maximum number. For example, for the SCS<=60 kHz, and the maximum number is 4. For the SCS>60 kHz, and the maximum number is 8.

In some embodiments, the network device 120 may define the maximum time duration for all the hopping sub-bands: for example, 1 ms. The maximum time duration may be associated with the length of measurement gap. The maximum time duration may be also associated with the speed of UE: higher speed, shorter time duration. For example, for UE speed <−60 km/h, and the maximum time duration may be Ims. For the UE speed >60 km/h, and the maximum time duration may be 0.5 ms.

In some embodiments, the gNB may measure the UE's speed based on a UL RS, or based on the performance. It should be noted that the UL RS for measuring the UE's speed may be not the SRS.

In some other embodiments, the UE may report the speed information to the network device 120 (for example the gNB). In some embodiments, the UE may determine the speed by measuring the speed according to the received RS. In some other embodiments, the UE may determine the speed based on the kinds of sensors installed on the UE, for example the sensors installed on the RedCap UEs.

In some embodiments, the format of the speed information may be an absolute speed. In some other embodiments, the format of the speed information may be both the absolute speed and a moving direction of the UE.

In some embodiments, the format of the speed information may be speed level. In some other embodiments, the format of the speed information may be both the speed level and a moving direction grid of the UE.

In some embodiments, the format of the speed information may be quantized speed. In some other embodiments, the format of the speed information may be both quantized speed and the direction of the UE.

In some embodiments, the speed information may be determined indirectly based on requirements of additional DMRS. Larger the number of groups for additional DMRS required, larger the speed is reported.

In some embodiments, the maximum time duration for all the hopping sub-bands may be associated with the configuration of additional DMRS: more additional DMRS symbols, shorter time duration. For example, for only front-loaded DMRS, the maximum time duration is 1 ms. For one group of additional DMRS symbol(s), the maximum time duration is 0.5 ms. For two group of additional DMRS symbol(s), the maximum time duration is 0.25 ms.

With reference to FIG. 3, based on the determined overlapped bandwidth and the time gap between two adjacent sub-bands, the network device 120 may determine the size of total bandwidth: B+(Nₘₐₓ−1)*(B−B₀)≤100 MHz, Nₘₐₓ is the determined maximum number of sub-bands which meets the three conditions (i.e. the size of total bandwidth is no larger than 100 MHz, the number of sub-bands is no larger than the defined maximum number of sub-bands, and the time duration is within the limits defined (no larger than the maximum time duration), B is the size of sub-band, which may be the maximum bandwidth supported by the terminal device, B₀ is the determined size of overlapped bandwidth.

In some embodiment, based on the determined overlapped bandwidth and the time gap between two adjacent sub-bands, the network device 120 may determine the size of total bandwidth: B+(Nₘₐₓ−1)*(B−B₀)≤B_{f} MHz, Nₘₐₓ is the determined maximum number of sub-bands which meets the three conditions (i.e. the size of total bandwidth is no larger than B_{f} MHz, the number of sub-bands is no larger than the defined maximum number of sub-bands, and the time duration is within the limits defined (no larger than the maximum time duration), B is the size of sub-band, which may be the maximum bandwidth supported by the terminal device, B₀ is the determined size of overlapped bandwidth, and B_{f} is the pre-defined or pre-configured total bandwidth, it's may be determined according to scenarios or positioning requirements.

As mentioned above, the network device 120 may configure the hopping pattern according to the scenarios. Different requirements for different scenarios due to different positioning accuracy is required for different scenarios. The positioning requirements, for example, phase error requirements (maximum phase error) signal/PRS, time error requirements (maximum time error) signal/PRS, time gap requirements (maximum time gap) signal/PRS, etc.

In some embodiments, a same UE may be located in different scenarios in different time. For the hopping pattern configuration, in some embodiments, the network device 120 may configure a same hopping pattern for the UE for different scenarios. The RedCap UE may support multiple levels of capabilities related to positioning. Higher capability for high accuracy positioning, lower capability for low accuracy positioning. The scenarios may be indicated to RedCap UE by the network device 120, for example, RRC and/or MAC-CE indicate(s) the scenario according to a rough positioning result, scheduling information. The RedCap UE may switch the hardware/software related to different capabilities. A lower capability for lower positioning requirement to save power for higher battery life.

In some embodiments, the network device 120 may configure different hopping patterns for the UE for different scenarios. Smaller overlapped bandwidth, less hopping sub-bands for scenarios with lower positioning accuracy. Larger overlapped bandwidth, more hopping sub-bands for scenarios with higher positioning accuracy. In some embodiments, the gNB (an example of the network device 120) may determine the scenarios according to the rough positioning results, scheduling information. In some other embodiments, a new requirement of positioning may be activated by the RedCap UE itself (holder inputs requirements). In some embodiments, the new requirement can be replaced by a scenario too. The gNB may re-configure the hopping pattern according to the requirements required or scenario activated by the RedCap UE.

In some embodiments, combined with capability to pre-define multiple relationships for the hopping pattern parameters, for example, for a scenario A, no hopping pattern is configured; for a scenario B, a hopping pattern A with small overlapped bandwidth sets ( 2/4 RB) is configured; for a scenario C, a hopping pattern B with large overlapped bandwidth sets ( 4/8 RB) is configured.

According to the present disclosure, frequency hopping pattern definition and configuration, including related capability reporting/measurement are proposed, and the frequency hopping pattern may be defined to enable the frequency hopping scheme, and a high enough accuracy of positioning for the RedCap UE is ensured.

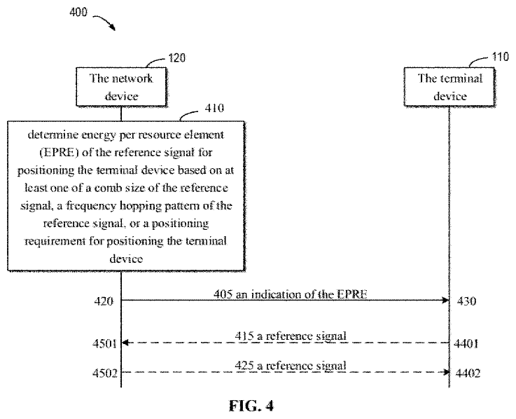

FIG. 4 illustrates a schematic diagram illustrating a process of communication between a terminal device 110 and a network device 120 according to some other embodiments of the present disclosure. As shown a process 400 in FIG. 4, the network device 120 may determine (410) energy per resource element (EPRE) of the reference signal for positioning the terminal device 110 based on at least one of a comb size of the reference signal, a frequency hopping pattern of the reference signal, or a positioning requirement for positioning the terminal device 110. The network device 120 may transmit (420) an indication 405 of the EPRE to the terminal device 110. On the terminal device 110 side, the terminal device 110 may receive (430) from the network device 120, the indication 405 of energy per resource element (EPRE) determined based on at least one of the comb size of the reference signal, the frequency hopping pattern of the reference signal, or the positioning requirement for positioning the terminal device 110. The terminal device 110 may transmit (4401) or receive (4402) the reference signal (415 or 425) and data (not shown) based on the EPRE. On the network device 120 side, the network device 120 may receive (4501) or transmit (4502) the reference signal (415 or 425) and data (not shown). In some embodiments, the reference signal 415 may be sounding reference signal (SRS) 415, and the terminal device 110 may transmit (4401) the SRS 415 to the network device 120. In some embodiments, the reference signal 425 may be positioning reference signal (PRS) 425, and the network device 120 may transmit (4502) the PRS 425 to the terminal device 110.

In some embodiments, the network device 120 determines the EPRE, specifically, the network device 120 may determine, for a whole bandwidth for frequency hopping of the reference signal, resource elements (REs) for data transmission on a same symbol of the reference signal to be muted. In some other embodiments, the network device 120 may determine, for an overlapped bandwidth for the frequency hopping of the reference signal, the REs for data transmission on the same symbol of the reference signal to be muted.

In some embodiments, the network device 120 determines the REs for data transmission to be muted, specifically, the network device 120 may determine a plurality of data REs such that a plurality of pairs of adjacent data REs have a same frequency gap, a data RE being the RE among the resource elements (REs) for data transmission not to be muted. In some embodiments, the network device 120 may determine a plurality of muted REs such that a plurality of pairs of adjacent REs among a set of target REs have a same frequency gap, the set of target REs may comprise a plurality of muted REs and a plurality of REs for reference signal transmission. In some embodiments, the network device 120 may determine a plurality of muted REs such that the plurality of muted REs are located uniformly at the two sides of the reference signal. In some embodiments, the network device 120 may determine the plurality of data REs such that the plurality of data REs are next to each other in frequency domain. In some embodiments, the network device 120 may determine the plurality of muted REs such that the plurality of muted REs are next to each other in frequency domain. In some embodiments, one or more of the embodiments above may be combined to implement determining the REs for data transmission to be muted. In some embodiments, the indication of the EPRE indicates contents above mentioned in the one or more of the embodiments.

In some embodiments, the network device 120 determines the EPRE comprises determining a maximum EPRE value no more than 7.8 dB for downlink transmission, and determining a maximum EPRE value no more than 6 dB for uplink transmission.

According to the present disclosure, the network device 120 defines EPRE adjustment scheme and related configuration, and the EPRE value may be associated with the size of overlap sub-bands. Larger overlap size, lower EPRE value. The EPRE adjustment for PRS/SRS may assist the phase offset estimation.

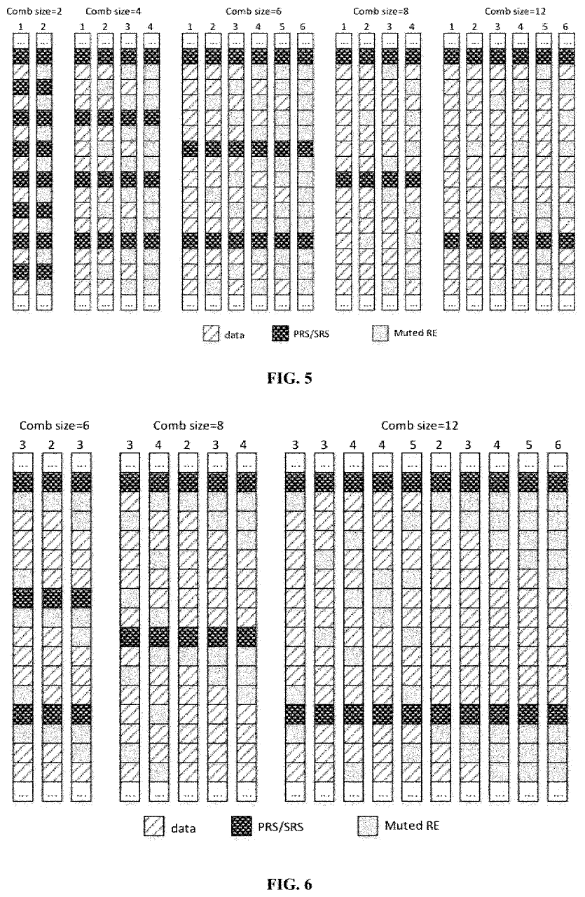

For the network device 120 determines, for the whole bandwidth for frequency hopping of the reference signal, REs for data transmission on a same symbol of the reference signal to be muted, in other words, the network device 120 increases EPRE for the PRS/SRS of the whole bandwidth. For example, as shown in FIG. 5, the EPRE value may be associated with the comb size: 2, 4, 6, 8, or 12. For downlink transmission, a maximum EPRE value may be no more than 7.8 dB. For uplink transmission, a maximum EPRE value may be no more than 6 dB (no RE is multiplexed with SRS in UL transmission). REs for data transmission are muted to provides additional EPRE to the PRS or the SRS. In some other embodiments, as shown in FIG. 6, the network device 120 increases EPRE for the PRS/SRS of the whole bandwidth, and the EPRE value may be associated with the comb size: 2, 4, 6, 8, or 12. With reference to FIG. 5 or FIG. 6, determining the REs for data transmission to be muted may be implemented by a plurality of ways, for example, the muted REs may be located regularly, and same step is applied between two adjacent muted REs; or the data REs are located regularly, and same step is applied between two adjacent data REs; or the muted REs/data REs may be located centralized. It should be noted that muted RE patterns for different comb size are illustrated just as examples.

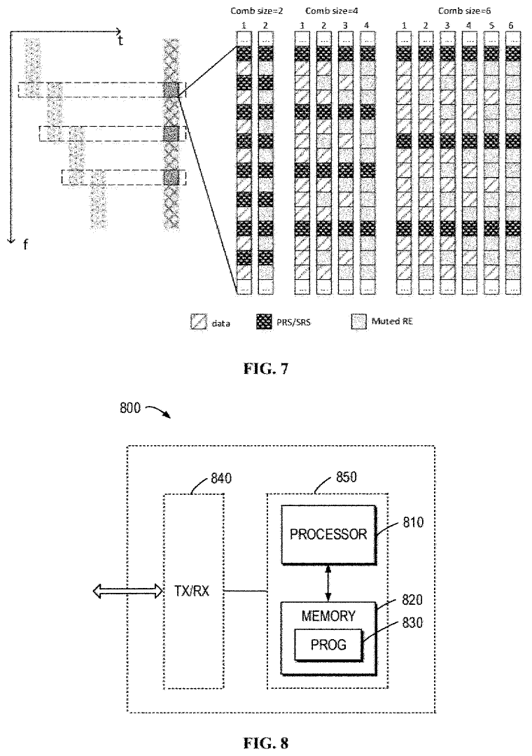

FIG. 7 illustrates a schematic diagram of increasing EPRE for the PRS/SRS of the overlapped bandwidth according to some other embodiments of the present disclosure. As shown in FIG. 7, The REs for data transmission on the overlapped RBs/bandwidth are muted to provide additional EPRE for PRS/SRS on the overlapped bandwidth, by this way, a better accuracy for phase offset estimation is expected. As an example, the muted REs are associated with the comb size 2, 4, 6, 8, or 12.

With one or more embodiments above, some related parameters and configurations are shown in Table 6.

TABLE 6

| | | BStoUE/ | | |
|---|---|---|---|---|
| Parameter/ | | UEtoBS/ | Via | |
| message | Case | predefined | channel | range |
| PhaseError | RedCap | UEtoBS | RRC | {variance/ |
| | UE | | | square |
| | | | | variance/ |
| | | | | maximum |
| | | | | absolute |
| | | | | error} |
| TimeError | RedCap | UEtoBS | RRC | {variance/ |
| | UE | | | square |
| | | | | variance/ |
| | | | | maximum |
| | | | | absolute |
| | | | | error} |
| MinTimeGapforFH | RedCap | UEtoBS | RRC | {X us} |
| | UE | | | |
| CapforFreqHop | RedCap | UEtoBS | RRC | {level 1: |
| | UE | | | (PhaseError, |
| | | | | TimeError, |
| | | | | MinTimeGap); |
| | | | | level 2: |
| | | | | (PhaseError, |
| | | | | TimeError, |
| | | | | MinTimeGap); |
| | | | | ...} |
| AccuracyRequire | RedCap | UEtoBS | RRC | {high, |
| | UE | | | medium, low} |

According the embodiments of the present disclosure, a frequency hopping pattern is defined to enable the frequency hopping scheme, by this way, a high enough accuracy of positioning for the terminal device 110, for example the RedCap UE, is ensured.

In summary, embodiments of the present disclosure may provide the following solutions.

A method of communication, comprises: receiving, at a network device 120 from a terminal device 110, at least one of capability information of the terminal device 110 associated with frequency hopping of a reference signal for positioning the terminal device 110, or estimation information of the terminal device 110; determining a positioning requirement for positioning the terminal device 110; determining at least one of a set of parameters of a frequency hopping pattern of the reference signal or a set of thresholds for determining the set of parameters, based on at least one of the capability information, the positioning requirement, or the estimation information; and transmitting, to the terminal device 110, at least one of the set of parameters or the set of thresholds for determining the set of parameters.

In one embodiment, the method as above, wherein the capability information of the terminal device 110 comprises at least one of: a distribution of a phase offset during the frequency hopping between two consecutive sub-bands of the reference signal; a distribution of a time error during the frequency hopping between the two consecutive sub-bands of the reference signal; a minimum time gap between the two consecutive sub-bands for the frequency hopping of the reference signal; or a maximum number of sub-bands of the reference signal.

In one embodiment, the method as above, wherein the set of parameters comprise at least one of: the number of the sub-bands; a size of an overlapped bandwidth between the two consecutive sub-bands; a time gap between the two consecutive sub-bands; a size of a sub-band; a size of a total bandwidth of a plurality of sub-bands of the frequency hopping pattern; a location of a sub-band; the number of symbols per sub-band; or a total time duration of the plurality of sub-bands of the frequency hopping pattern.

In one embodiment, the method as above, wherein determining the set of parameters comprises: based on at least one of the phase offset or the time error, and the positioning requirement on at least one of the phase offset or the time error, determining existence of the overlapped bandwidth between the sub-bands; and determining the size of the overlapped bandwidth based on association of the size of the overlapped bandwidth and at least one of: a signal-to-noise ratio (SNR), a signal to interference plus noise ratio (SINR), reference signal received power (RSRP) or a modulation and scheme (MCS).

In one embodiment, the method as above, wherein determining the existence of the overlapped bandwidth between the sub-bands comprises at least one of: determining that the phase offset is greater than a first predefined value; or determining that the phase offset is greater than a second predefined value, and the time error is greater than a third predefined value; wherein the first predefined value, the second predefined value, or the third predefined value are associated with the positioning requirement.

In one embodiment, the method as above, further comprises: based on the time error, determining the association of the size of the overlapped bandwidth and at least one of: the SNR, the SINR, the RSRP or the MCS.

In one embodiment, the method as above, wherein determining the set of parameters comprises: based on at least one of the minimum time gap, a measurement gap for a plurality of reference signals including the reference signal, speed information reported by the terminal device 110, or the number of the sub-bands, determining the time gap between the sub-bands.

In one embodiment, the method as above, wherein determining the set of parameters comprises: determining the size of a total bandwidth of a plurality of sub-bands of the frequency hopping pattern as a fixed value; determining the size of the sub-band as a maximum bandwidth supported by the terminal device 110.

In one embodiment, the method as above, determining the set of parameters comprises: based on the fixed value of total bandwidth, the size of the sub-band, and the size of the overlapped bandwidth, determining the number of the sub-bands.

In one embodiment, the method as above, wherein determining the set of parameters comprises: based on the size of the total bandwidth of the plurality of sub-bands of the frequency hopping pattern, a defined maximum number of the plurality of sub-bands, and a defined maximum time duration for the plurality of sub-bands, determining the number of sub-bands, the size of the total bandwidth being fixed or defined by the network device 120 or associated with the positioning requirement.

In one embodiment, the method as above, further comprises: based on at least one of subcarrier spacing (SCS) of the reference signal or the capability information of the terminal device 110, determining the defined maximum number of the plurality of sub-bands.

In one embodiment, the method as above, further comprises: based on at least one of a measurement gap for a plurality of reference signals including the reference signal, speed information of the terminal device 110 or a configuration of additional demodulation reference signal (DMRS), determining the defined maximum time duration for the plurality of sub-bands.

In one embodiment, the method as above, wherein a format of the speed information is one of: an absolute speed or both the absolute speed and a moving direction of the terminal device 110; a speed level or both the speed level and a moving direction grid of the terminal device 110; or a quantized speed or both the quantized speed and a direction of the terminal device 110.

In one embodiment, the method as above, the estimation information comprising at least one of: a SNR or a SINR received from the terminal device 110 via a radio resource control (RRC) signaling; or speed information of the terminal device 110.

In one embodiment, the method as above, wherein the positioning requirement comprises at least one of: a phase offset requirement during the frequency hopping between two consecutive sub-bands of the reference signal; a time error requirement during the frequency hopping between the two consecutive sub-bands; a time gap requirement between the sub-bands; or a required positioning accuracy in vertical and horizontal.

A method of communication, comprises: transmitting, at a terminal device 110 to a network device 120, at least one of capability information of the terminal device 110 associated with frequency hopping of a reference signal for positioning the terminal device 110, or estimation information of the terminal device 110; receiving, from the network device 120, a set of parameters of a frequency hopping pattern or a set of thresholds for determining the set of parameters, the set of parameters or the set of thresholds being determined based on at least one of the capability information, a positioning requirement for positioning the terminal device 110, or the estimation information; and transmitting or receiving the reference signal based on the frequency hopping pattern.

In one embodiment, the method as above, wherein the capability information of the terminal device 110 comprises at least one of: a distribution of a phase offset during the frequency hopping between two consecutive sub-bands for the reference signal; a distribution of a time error during the frequency hopping between the two consecutive sub-bands for the reference signal; or a minimum time gap between the two consecutive sub-bands for the frequency hopping of the reference signal; or a maximum number of sub-bands of the reference signal.

In one embodiment, the method as above, wherein the set of parameters comprise at least one of: the number of the sub-bands; a size of an overlapped bandwidth between the two consecutive sub-bands; a time gap between the two consecutive sub-bands; a size of a sub-band; a size of a total bandwidth of a plurality of sub-bands of the frequency hopping pattern; a location of a sub-band; the number of symbols per sub-band; or a total time duration of the plurality of sub-bands of the frequency hopping pattern.

In one embodiment, the method as above, wherein transmitting the estimation information comprises: reporting a measured signal-to-noise ratio (SNR) or a measured signal to interference plus noise ratio (SINR) to the network device 120 for determining the set of parameters.

In one embodiment, the method as above, wherein transmitting the estimation information comprises: transmitting, to the network device 120, speed information of the terminal device 110 measured based on received reference signal or obtained from a sensor of the terminal device 110.

In one embodiment, the method as above, wherein a format of the speed information is one of: an absolute speed or both the absolute speed and a moving direction of the terminal device 110; a speed level or both the speed level and a moving direction grid of the terminal device 110; or a quantized speed or both the quantized speed and a direction of the terminal device 110.

In one embodiment, the method as above, wherein the positioning requirement comprises at least one of: a phase offset requirement during the frequency hopping between two consecutive sub-bands of the reference signal; a time error requirement during the frequency hopping between the two consecutive sub-bands; a time gap requirement between the sub-bands; or a required positioning accuracy in vertical and horizontal.

In one embodiment, the method as above, further comprises: based on the set of thresholds and the capability information, determining the frequency hopping pattern for transmitting or receiving the reference signal.

In one embodiment, the method as above, further comprises: transmitting, to the network device 120, the positioning requirement for positioning the terminal device 110.

A method of communication, comprises: determining, at a network device 120, energy per resource element (EPRE) of a reference signal for positioning a terminal device 110 based on at least one of a comb size of the reference signal, a frequency hopping pattern of the reference signal, or a positioning requirement for positioning the terminal device 110; and transmitting an indication of the EPRE to the terminal device 110.

In one embodiment, the method as above, wherein determining the EPRE comprises one of: determining, for a whole bandwidth for frequency hopping of the reference signal, resource elements (REs) for data transmission on a same symbol of the reference signal to be muted; or determining, for an overlapped bandwidth for the frequency hopping of the reference signal, the REs for data transmission on the same symbol of the reference signal to be muted.

In one embodiment, the method as above, wherein determining the REs for data transmission to be muted comprises at least one of: determining a plurality of data REs such that a plurality of pairs of adjacent data REs have a same frequency gap, a data RE being the RE among the resource elements (REs) for data transmission not to be muted; determining a plurality of muted REs such that a plurality of pairs of adjacent REs among a set of target REs have a same frequency gap, the set of target REs comprising a plurality of muted REs and a plurality of REs for reference signal transmission; determining a plurality of muted REs such that the plurality of muted REs are located uniformly at the two sides of the reference signal; determining the plurality of data REs such that the plurality of data REs are next to each other in frequency domain; or determining the plurality of muted REs such that the plurality of muted REs are next to each other in frequency domain.

In one embodiment, the method as above, wherein determining the EPRE comprises: determining a maximum EPRE value no more than 7.8 dB for downlink transmission; and determining a maximum EPRE value no more than 6 dB for uplink transmission.

A method of communication, comprises: receiving, at a terminal device 110 from a network device 120, an indication of energy per resource element (EPRE) determined based on at least one of a comb size of a reference signal, a frequency hopping pattern of the reference signal, or a positioning requirement for positioning the terminal device 110; and transmitting or receiving the reference signal based on the EPRE.

In one embodiment, the method as above, wherein transmitting or receiving the reference signal based on one of: for a whole bandwidth for frequency hopping of the reference signal, resource elements (REs) for data transmission on a same symbol of the reference signal being muted; for an overlapped bandwidth for the frequency hopping of the reference signal, the REs for data transmission on the same symbol of the reference signal being muted.

In one embodiment, the method as above, wherein the indication of the EPRE indicates one of: determining a plurality of data REs such that a plurality of pairs of adjacent data REs have a same frequency gap, a data RE being the RE among the resource elements (REs) for data transmission not to be muted; determining a plurality of muted REs such that a plurality of pairs of adjacent REs among a set of target REs have a same frequency gap, the set of target REs comprising a plurality of muted REs and a plurality of REs for reference signal transmission; determining a plurality of muted REs such that the plurality of muted REs are located uniformly at the two sides of the reference signal; determining the plurality of data REs such that the plurality of data REs are next to each other in frequency domain; or determining the plurality of muted REs such that the plurality of muted REs are next to each other in frequency domain.

In one embodiment, the method as above, wherein: a maximum EPRE value being no more than 7.8 dB for downlink transmission; and a maximum EPRE value being no more than 6 dB for uplink transmission.

A network device 120 comprises: a processor; and a memory storing computer program codes; the memory and the computer program codes configured to, with the processor, cause the network device 120 to perform the method according to the methods above.

A terminal device 110 comprises: a processor; and a memory storing computer program codes; the memory and the computer program codes configured to, with the processor, cause the terminal device 110 to perform the method according to the methods above.

A computer readable medium having instructions stored thereon, the instructions, when executed by a processor of an apparatus, causing the apparatus to perform the method according to the methods above.

FIG. 8 illustrates a simplified block diagram of a device 800 that is suitable for implementing embodiments of the present disclosure. The device 800 can be considered as a further example implementation of the terminal device 110 and/or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device 110.

The program 830 is assumed to include program instructions that, when executed by the associated processor 810, enable the device 800 to operate in accordance with the embodiments of the present disclosure, as discussed herein with reference to FIGS. 2-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of communication, comprising:
receiving, at a network device from a terminal device, capability information of the terminal device associated with frequency hopping of a reference signal for positioning the terminal device;
determining a set of parameters of a frequency hopping pattern of the reference signal based on the capability information; and
transmitting, to the terminal device, the set of parameters.

22. The method of claim 21, wherein the capability information of the terminal device comprises at least one of:
a minimum time gap between the two consecutive sub-bands for the frequency hopping of the reference signal; or
a maximum number of sub-bands of the reference signal.

23. The method of claim 22, wherein the set of parameters comprise at least one of:
a number of the sub-bands;
a size of an overlapped bandwidth between the two consecutive sub-bands;
a size of a sub-band;
a start location of each hop in time domain;
a number of symbols per sub-band; or
a total time duration of the plurality of sub-bands of the frequency hopping pattern.

24. The method of claim 21, wherein the value set for the size of the overlapped bandwidth between the two consecutive sub-bands is {0, 1, 2, 4}.

25. The method of claim 21, further comprising:
determining, at the network device, energy per resource element (EPRE) of the reference signal based on at least one of a comb size of the reference signal, the frequency hopping pattern of the reference signal, or a positioning requirement for positioning the terminal device; and
transmitting an indication of the EPRE to the terminal device.

26. The method of claim 25, wherein determining the EPRE comprises one of:
determining, for a whole bandwidth for frequency hopping of the reference signal, resource elements (REs) for data transmission on a same symbol of the reference signal to be muted; or
determining, for an overlapped bandwidth for the frequency hopping of the reference signal, the REs for data transmission on the same symbol of the reference signal to be muted.

27. The method of claim 25, wherein determining the REs for data transmission to be muted comprises at least one of:
determining a plurality of data REs such that a plurality of pairs of adjacent data REs have a same frequency gap, a data RE being the RE among the resource elements (REs) for data transmission not to be muted;
determining a plurality of muted REs such that a plurality of pairs of adjacent REs among a set of target REs have a same frequency gap, the set of target REs comprising a plurality of muted REs and a plurality of REs for reference signal transmission;
determining a plurality of muted REs such that the plurality of muted REs are located uniformly at the two sides of the reference signal;
determining the plurality of data REs such that the plurality of data REs are next to each other in frequency domain; or
determining the plurality of muted REs such that the plurality of muted REs are next to each other in frequency domain.

28. The method of claim 25, wherein determining the EPRE comprises:
determining a maximum EPRE value no more than 7.8 dB for downlink transmission; and
determining a maximum EPRE value no more than 6 dB for uplink transmission.

29. A method of communication, comprising:
transmitting, at a terminal device to a network device, capability information of the terminal device associated with frequency hopping of a reference signal for positioning the terminal device;
receiving, from the network device, a set of parameters of a frequency hopping pattern, the set of parameters or the set of thresholds being determined based on the capability information; and
transmitting or receiving the reference signal based on the frequency hopping pattern.

30. The method of claim 29, wherein the capability information of the terminal device comprises at least one of:
a minimum time gap between the two consecutive sub-bands for the frequency hopping of the reference signal; or
a maximum number of sub-bands of the reference signal.

31. The method of claim 30, wherein the set of parameters comprise at least one of:
a number of the sub-bands;
a size of an overlapped bandwidth between the two consecutive sub-bands;
a size of a sub-band;
a start location of each hop in time domain a location of a sub-band;
a number of symbols per sub-band; or
a total time duration of the plurality of sub-bands of the frequency hopping pattern.

32. The method of claim 29, wherein the value set for the size of the overlapped bandwidth between the two consecutive sub-bands is {0, 1, 2, 4}.

33. The method of claim 29, further comprising:
receiving, at the terminal device from the network device, an indication of energy per resource element (EPRE) determined based on at least one of a comb size of a reference signal, the frequency hopping pattern of the reference signal, or a positioning requirement for positioning the terminal device; and
transmitting or receiving the reference signal based on the EPRE.

34. The method of claim 33, wherein transmitting or receiving the reference signal based on one of:
for a whole bandwidth for frequency hopping of the reference signal, resource elements (REs) for data transmission on a same symbol of the reference signal being muted;
for an overlapped bandwidth for the frequency hopping of the reference signal, the REs for data transmission on the same symbol of the reference signal being muted.

35. The method of claim 33, wherein the indication of the EPRE indicates one of:
determining a plurality of data REs such that a plurality of pairs of adjacent data REs have a same frequency gap, a data RE being the RE among the resource elements (REs) for data transmission not to be muted;
determining a plurality of muted REs such that a plurality of pairs of adjacent REs among a set of target REs have a same frequency gap, the set of target REs comprising a plurality of muted REs and a plurality of REs for reference signal transmission;
determining a plurality of muted REs such that the plurality of muted REs are located uniformly at the two sides of the reference signal;
determining the plurality of data REs such that the plurality of data REs are next to each other in frequency domain; or
determining the plurality of muted REs such that the plurality of muted REs are next to each other in frequency domain.

36. The method of claim 33, wherein:
a maximum EPRE value being no more than 7.8 dB for downlink transmission; and
a maximum EPRE value being no more than 6 dB for uplink transmission.

37. A terminal device, comprising:
a processor configured to cause the terminal device to:
transmit, to a network device, capability information of the terminal device associated with frequency hopping of a reference signal for positioning the terminal device;
receive, from the network device, a set of parameters of a frequency hopping pattern, the set of parameters or the set of thresholds being determined based on the capability information; and
transmit or receive the reference signal based on the frequency hopping pattern.

38. The terminal device of claim 37, wherein the capability information of the terminal device comprises at least one of:
a minimum time gap between the two consecutive sub-bands for the frequency hopping of the reference signal; or
a maximum number of sub-bands of the reference signal.

39. The terminal device of claim 38, wherein the set of parameters comprise at least one of:
a number of the sub-bands;
a size of an overlapped bandwidth between the two consecutive sub-bands;
a size of a sub-band;
a start location of each hop in time domain a location of a sub-band;
a number of symbols per sub-band; or
a total time duration of the plurality of sub-bands of the frequency hopping pattern.

40. The terminal device of claim 37, wherein the value set for the size of the overlapped bandwidth between the two consecutive sub-bands is {0, 1, 2, 4}.
